(19) United States
(12) Patent Application Publication
(10) Pub. No.: US 2021/0359339 A1
(43) Pub. Date: Nov. 18, 2021

(54) CATHODE FOR SOLID-STATE LITHIUM BATTERY

(71) Applicant: Apple Inc., Cupertino, CA (US)

(72) Inventors: Sally S. Lou, San Jose, CA (US); Daniel J. Hoffman, Ft. Collins, CO (US); Juchuan Li, San Jose, CA (US)

(21) Appl. No.: 17/318,203

(22) Filed: May 12, 2021

Related U.S. Application Data
(60) Provisional application No. 63/023,364, filed on May 12, 2020.

(51) Int. Cl. H01M 10/0562; H01M 10/0525; H01M 4/505; H01M 4/525

(52) U.S. Cl. CPC H01M 10/0562; H01M 10/0525; H01M 2300/0051; H01M 4/525; H01M 4/505

(57) ABSTRACT

The disclosure provides a solid-state battery including a cathode comprising a lithium-based conducting material having a porosity less than or equal to 6% and a surface roughness of equal to or less than 300 nm. The solid-state battery may also include an anode and a solid electrolyte between the cathode and the anode.

### PRIORITY

This patent application claims the benefit under 35 U.S.C. § 119(e) of U.S. Patent Application Ser. No. 63/023,364, entitled “Cathode for Solid-State Lithium Battery,” filed on May 12, 2020, which is incorporated herein by reference in its entirety.

### FIELD

The disclosure is directed to fabricating high capacity fully solid-state lithium batteries from solid cathodes.

### BACKGROUND

Recently, the solid-state lithium (ion) battery has been identified as one of the candidate power sources for various applications. There remains a need to develop solid state lithium batteries with enhanced electrochemical performance.

### BRIEF SUMMARY

The disclosure provides a solid-state battery. In an embodiment, the solid-state battery may include a cathode comprising a lithium-based conducting material having a porosity less than or equal to 6% and a surface roughness of equal to or less than 300 nm. The solid-state battery may also include an anode and a solid electrolyte between the cathode and the anode.

In an embodiment, the solid-state battery may include a cathode comprising a lithium-based conducting material having a diffusivity between 1×10⁻⁹ and 1×10⁻⁸ cm²/s. The solid-state battery may also include an anode and a solid electrolyte between the cathode and the anode.

In an embodiment, the solid-state battery may include a cathode comprising a lithium-based conducting material. The solid-state battery may also include an anode and a solid electrolyte between the cathode and the anode. The battery has a resistance between 40 Ω·cm² and 200 Ω·cm²

In an embodiment, the disclosure provides a method of forming the cathode. The method may include forming the cathode by a film deposition technique. The method may also include polishing a surface of the cathode. The method may further include re-activating the surface of the cathode by cleaning through oxygen plasma treatment. In some embodiments, the film deposition technique may include electroplating.

Additional embodiments and features are set forth in part in the description that follows, and will become apparent to those skilled in the art upon examination of the specification or may be learned by the practice of the disclosed subject matter. A further understanding of the nature and advantages of the disclosure may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure, wherein:

FIG. 1 shows a structure of a solid-state lithium battery in accordance with embodiments of the disclosure;

FIG. 2 is a flow chart illustrating the steps for forming a polished and cleaned cathode in accordance with embodiments of the disclosure;

FIG. 3 shows the capacity, yield, and surface roughness for cathodes in an as-deposited condition, a polished condition, and a polished and plasma-activated condition in accordance with embodiments of the disclosure;

FIG. 4 shows capacity versus cathode thickness for a solid-state Li battery in accordance with embodiments of the disclosure;

FIG. 5 shows energy density versus cathode thickness for a solid-state Li battery in accordance with embodiments of the disclosure;

FIG. 6 shows a scanning electron microscope (SEM) image of a cross-section of the disclosed electroplated cathode illustrating high relative density and low porosity in accordance with embodiments of the disclosure;

FIG. 7 shows a SEM image of a cross-section of an electroplated cathode for a conventional battery with liquid electrolyte illustrating low density and high porosity in accordance with embodiments of the disclosure;

FIG. 8 shows a SEM image of a cross-section of an as-deposited cathode illustrating high surface roughness in accordance with embodiments of the disclosure;

FIG. 9 shows a SEM image of a cross-section of a polished cathode illustrating low surface roughness in accordance with embodiments of the disclosure;

FIG. 10 shows higher Li ion diffusivity of the disclosed electroplated cathode than conventional cathode materials in accordance with embodiments of the disclosure;

FIG. 11 shows atomic concentrations of various elements including carbon (C), fluorine (F), oxygen (O), lithium (Li), and cobalt (Co) versus sputter depth for a polished cathode surface in accordance with embodiments of the disclosure;

FIG. 12 shows XPS spectra of an as-deposited cathode surface and a polished cathode surface in accordance with embodiments of the disclosure.

FIG. 13 shows capacity versus cycles for solid-state Li batteries in accordance with embodiments of the disclosure;

FIG. 14 shows resistance versus cycles for solid-state Li batteries in accordance with embodiments of the disclosure; and

FIG. 15 shows capacity versus discharge rates for solid-state Li batteries in accordance with embodiments of the disclosure.

### DETAILED DESCRIPTION

The disclosure may be understood by reference to the following detailed description, taken in conjunction with the drawings as described below. It is noted that, for purposes of illustrative clarity, certain elements in various drawings may not be drawn to scale.

### Overview

Solid-state lithium batteries, and cathodes for a solid-state lithium battery, are provided. The disclosed solid-state lithium (ion) battery including an electroplated cathode has improved properties over conventional solid state batteries. These properties include one or more of enhanced capacity, energy density, and rate performance compared to a conventional lithium (Li)-ion battery with a liquid electrolyte.

Composite cathode for conventional lithium ion batteries include of lithium transition metal oxide active particles, conducting additives, and binders. Upon charging and discharging, lithium transport among active particles can be realized through the infiltrated liquid electrolyte. Since there is no flowable liquid electrolyte in a solid-state battery, cathode structures can realize Li transportation without compromising performance of the battery. Cathodes can have high relative density and low porosity, low surface roughness, clean interface to ensure facile interfacial kinetics, good rate performance, high energy density, and/or stable cycle performance in solid-state batteries.

### Solid-State Lithium Battery

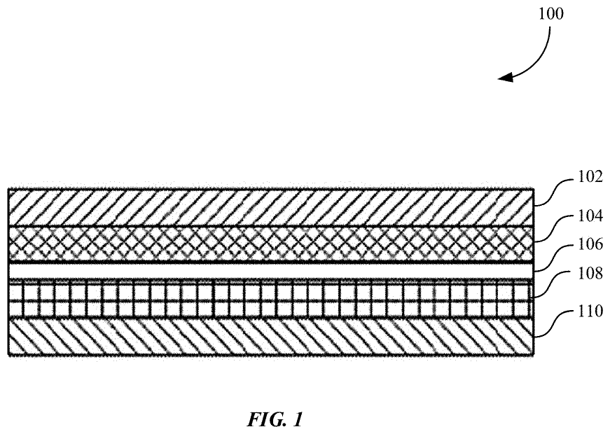

FIG. 1 shows a structure of a solid-state lithium battery in accordance with embodiments of the disclosure. A solid-state lithium battery 100 includes an anode current collector 102 and a metal anode 104. The metal anode 104 may be a Li metal anode among others. In some variations, the anode includes a Li metal, among others. In some variations, the anode may have a thickness ranging from 5 to 20 μm. The battery 100 further includes a current collector or a conductive substrate 110 for supporting a cathode 108. The current collector 110 may be formed of various conducting materials, including aluminum, an aluminum foil, stainless steel, and other materials.

The battery 100 also includes a solid electrolyte 106 between the cathode 108 and the anode 104. In some variations, the solid electrolyte includes lithium phosphorous oxy-nitride, or LiPON, among others. In some variations, the solid electrolyte may have a thickness ranging from 1 to 2 μm.

The battery 100 also includes the cathode 108, which is an electronically conducting material. In some variations, the cathode is formed of a material selected from the group consisting of LiCoO₂, LiNiO₂, LiMn₂O₄, LiNi_{0.5}Mn_{1.5}O₄, Li(Ni_{1/3}Mn_{1/3}Co_{1/3})O₂, Li(Ni_{0.8}Co_{0.1}Al_{0.1})O₂, and Li₃VO₄. In some variations, the cathode includes an electroplated LiCoO₂.

The cathode 108 can have one or more characteristics, as follows. (1) In some variations, the cathode can have a low porosity and high relative density, such as a porosity of less than 6% and a relative density of greater than 94%, which can help solid-state ion diffusion in cathode. (2) In some variations, the cathode can further have a low surface roughness, such as a roughness of less than 300 nm, which can increase the yield of solid-state battery. (3) In some variations, the surface of cathode can be clean, e.g. free of carbonate to have intimate contact at a cathode/solid electrolyte interface, thereby allowing facile charge transfer and good electrochemical performance. (4) In some variations, the thickness of cathode is higher than the thickness of conventional solid state battery cathodes (e.g., between 10 μm and 200 μm). (5) In some variations, the cathode has higher diffusivity (e.g., an effective/apparent D between 1×10⁻⁹ and 1×10⁻⁸ cm²/s) than conventional solid state cathodes. (6) In some variations, the cell has a resistance, e/g/. DCIR, ranges between 40 and 200 Ω·cm². One or more of these characteristics can be present in the cathodes in any combination.

### Processes

The process flow for fabricating the solid-state battery can include one or steps of: (1) Fabricating the cathode (e.g. LiCoO₂) by means of film deposition techniques, such as electrodeposition, to achieve high relative density; (2) Reducing the surface roughness, e.g., by using mechanical polishing or electric polishing; (3) Re-activating the cathode by using thermal annealing, plasma treatment, laser treatment, or electron beam treatment; and (4) Depositing electrolyte and anode by using, e.g., sputtering and evaporation.

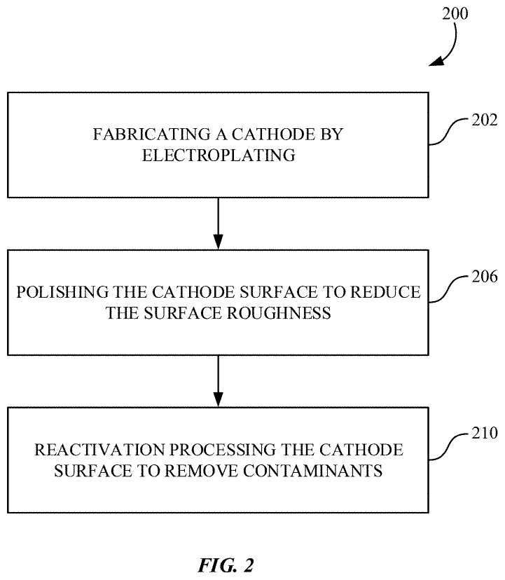

FIG. 2 is a flow chart illustrating the steps for forming a polished and cleaned cathode in accordance with embodiments of the disclosure. A method 200 includes fabricating a cathode by electroplating at operation 202. The cathode has a high relative density (e.g. >94%) and a low porosity (e.g. <6%). The high relative density and low porosity allows solid-state ion diffusion in the cathode in absence of mobile liquid electrolyte.

High relative density and low porosity can be related by the following equation:

Relative density=100%−porosity

Porosity and relative density can be determined by measurements using an Archimedes method. Porosity and relative density can also be determined by using microscopy and image analysis for 2D porosity or relative density, and then 3D porosity or density can be calculated.

The method 200 includes a step of polishing the cathode surface to reduce the surface roughness at operation 206. The as-deposited cathode has a high surface roughness and results in a low production yield. A low surface roughness can be a factor for providing a higher sufficient yield of solid-state battery. The polishing includes mechanical polishing, electrochemical-mechanical polishing, electric polishing, or laser ablation, among others.

In some variations, the cathode polishing process can include the following steps. First, the cathode can be polished by using a grinding machine or manually with a grinding paper. Second, a polishing process can be started from a course grinding paper and progressively moved to a fine grinding paper. (The grit of the grinding papers is a rating of the size of abrasive materials on the grinding paper. Higher grit number is equivalent to a finer abrasive, which creates smoother surface finishes. Lower grit numbers represent coarser abrasives that scrape off materials more quickly. In various aspects, the grinding paper can have various grades including 400, 800, 1200, 1600, and 2000.) The cathode sample can be rotated, for example by 90°, between each abrasive step. Third, after each abrasive step, the cathode can be rinsed, e.g., in isopropyl alcohol, acetone, or water, to remove residual abrasive.

The yield was substantially improved when the surface roughness of the cathode was reduced. However, the polishing often deteriorated the surface chemical structures, leading to a compromised performance from cathode, for example, reduced capacity. The method 200 further can include a re-activation process to remove contaminants including lithium carbonates from the polished cathode surface at operation 210. The re-activation process can be thermal annealing, plasma treatment, laser treatment, or electron-beam treatment, among others, which can renew surface chemistry/phase purity of the cathode. For example, the plasma treatment may include oxygen plasma treatment. Oxygen treatment is the process by which oxygen is ionized in a vacuum chamber to form an oxygen plasma and alter the surface of a material. The process is performed in a plasma chamber under low pressure. The oxygen plasma treatment can renew surface chemistry/phase purity of the cathode. With the re-activation process, the capacity of the battery can be substantially improved.

In some embodiments, the re-activation technique is plasma treatment. Plasma treatment can remove impurities and contaminants from surfaces through the use of an energetic plasma created from gaseous species. Gases such as argon and oxygen, as well as mixtures such as air and hydrogen/nitrogen, are used. The plasma is created by using high frequency voltages (typically kHz to MHz) to ionize the low pressure gas (e.g. about 1/1000 atmospheric pressure).

In some variations, an oxygen (O₂) or argon (Ar) plasma is used. Example process parameters for the oxygen plasma treatment include the following:

Gas type: Pure O₂ or pure Ar or mixture of O₂/Ar

Source and bias power: 0˜3 kW.

Plasma density: 10⁹˜10¹² cm⁻³ ion.

Ion energy: <500 eV.

Plasma treatment time: 5˜30 minutes.

By selecting the process parameters, oxygen plasma treatment can clean the surface to control the lithium carbonate layer. In some variations, the layer can be less than 0.01 nm thick and re-activate the cathode surface. With an ionic conductivity of 10⁻¹² S/cm at room temperature, as shown in Ref: Ken Saito, Kenshi Uchida and Meguru Tezuka, Lithium Carbonate as a Solid Electrolyte, Solid State Ionics, 53-56: 791-797. (1992), a carbonate layer of greater than 0.01 nm thick may add an additional resistance of greater than 1 Ω·cm² to the battery, and thus deteriorate the rate performance and kinetics of the battery. This reference is incorporated by reference in its entirety.

In some variations, deposition of an electrolyte includes depositing LiPON by using radio frequency (RF) sputtering with a lithium phosphate target. [Ref: (1) J. B. Bates, N. J. Dudney, G. R. Gruzalski, R. A. Zuhr, A. Choudhury, C. F. Luck, Electrical properties of amorphous lithium electrolyte thin films, Solid State Ionics, 53-56, 647-654 (1992). (2) Juchuan Li, Cheng Ma, Miaofang Chi, Chengdu Liang, and Nancy J. Dudney, Solid Electrolyte: the Key for High-Voltage Lithium Batteries. Advanced Energy Materials. 2015, 5, 1401408.] In some additional variations, deposition of an anode includes evaporating a Li metal anode by using a thermal evaporator or an E-beam evaporator.

The present technology is further illustrated by the following Examples, which should not be construed as limiting in any way.

### Polishing and Cleaning Cathode Surface

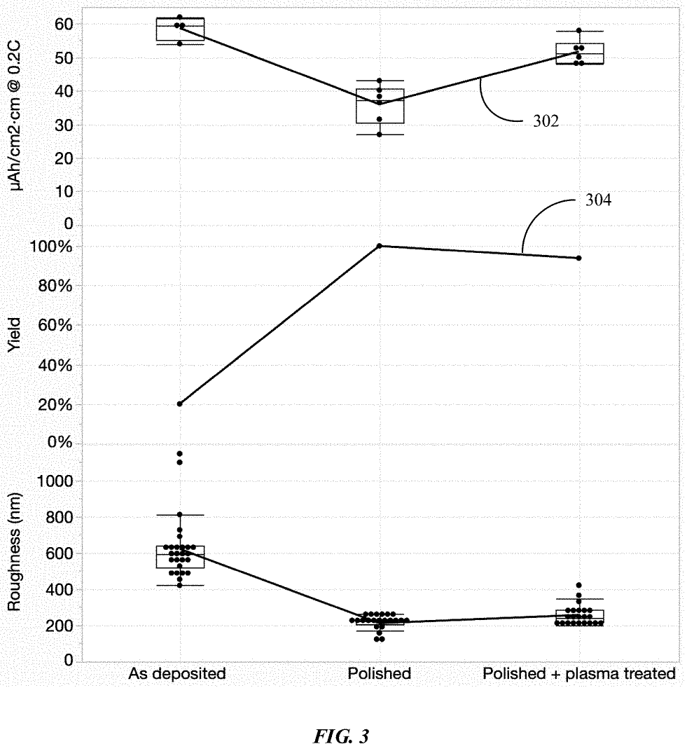

FIG. 3 shows the capacity, yield, and surface roughness for cathodes in an as-deposited condition, a polished condition, and a polished and plasma-activated condition in accordance with embodiments of the disclosure. Curve 302 represents capacity in an as-deposited condition, a polished condition, and a polished and plasma-activated condition. Curve 304 represents yield for cathodes in in an as-deposited condition, a polished condition, and a polished and plasma-activated condition.

As shown in FIG. 3, the as-deposited cathode had a high roughness (e.g. an average roughness of 591 nm), a low yield (e.g. a yield of 20%), and a high capacity (e.g. an average capacity of 58 μAh/cm²μm). The low yield of 20% was caused by a high surface roughness of 591 nm. Non-yield refers to short circuit or leakiness after 5 charge-discharge cycles.

The polished cathode had a low roughness (e.g. an average roughness of 214 nm), a high yield (e.g. 100%), and a low capacity (e.g. an average capacity of 37 μAh/cm²μm). For the cathode after polishing, surface roughness was substantially reduced by polishing process from 591 nm to less than 300 nm, and the yield was substantially improved from 20% to 100%. However, the capacity was reduced, which was due to a contaminated layer on the polished cathode. This will be discussed in further details in surface analysis.

As shown in FIG. 3, after a combination of polishing and plasma treatment, the cathode had a low roughness (e.g. an average roughness of 247 nm), a high yield (e.g. 94%), and a high capacity (e.g. an average capacity of 53 μAh/cm²μm). The results revealed that re-activation process by plasma treatment helped clean the cathode surface while maintaining the low surface roughness (e.g. less than 300 nm).

### Cathode Thickness

In some variations, the cathode may have a thickness ranging from 10 to 200 μm. In some variations, the cathode may have a thickness equal to or greater than 10 μm. In some variations, the cathode may have a thickness equal to or greater than 20 μm. In some variations, the cathode may have a thickness equal to or greater than 30 μm. In some variations, the cathode may have a thickness equal to or greater than 40 μm. In some variations, the cathode may have a thickness equal to or greater than 50 μm. In some variations, the cathode may have a thickness equal to or greater than 100 μm. In some variations, the cathode may have a thickness equal to or greater than 150 μm.

In some variations, the cathode may have a thickness less than or equal to 20 μm.

In some variations, the cathode may have a thickness less than or equal to 30 μm. In some variations, the cathode may have a thickness less than or equal to 40 μm. In some variations, the cathode may have a thickness less than or equal to 50 μm. In some variations, the cathode may have a thickness less than or equal to 100 μm. In some variations, the cathode may have a thickness less than or equal to 150 μm. In some variations, the cathode may have a thickness less than or equal to 200 μm.

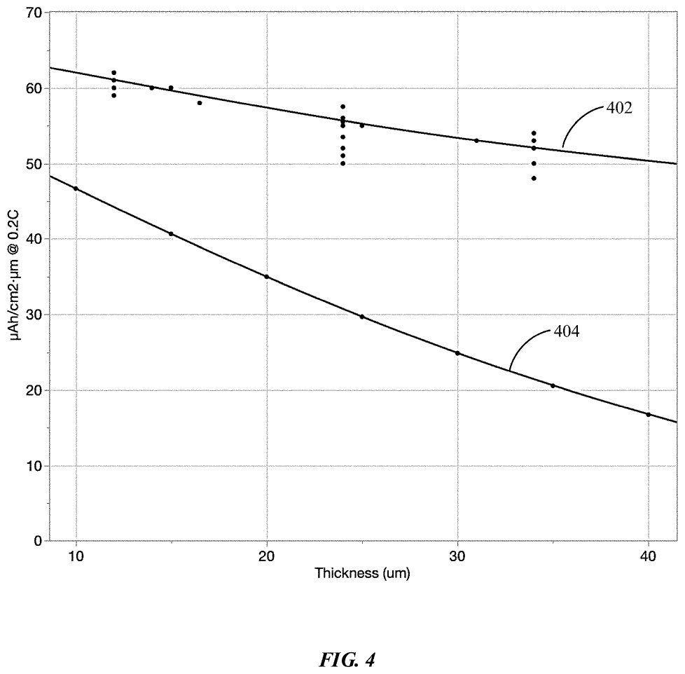

FIG. 4 shows capacity versus cathode thickness for a solid-state Li battery in accordance with embodiments of the disclosure. Curve 402 represents the capacity at a discharge rate of 0.2 C of the disclosed electroplated cathode for the solid-state lithium battery as a function of cathode thickness. Curve 404 represents the estimated capacity at 0.2 C of the fully dense cathode of a conventional battery as a function of cathode thickness. As shown in FIG. 4, the capacity decrease with cathode thickness is significantly slower for the disclosed cathode of the solid-state lithium battery than that of the conventional battery. For example, at a cathode thickness of 40 μm, the capacity of the solid-state lithium battery was about 50 μAh/cm²μm, which was about three times of the capacity of the conventional battery (i.e. about 16 μAh/cm²μm). As shown, the capacity was significantly higher for the solid-state lithium battery than the conventional battery. This increase in capacity under the same rate is caused by higher Li diffusivity in cathode. This will be discussed in further details in diffusivity.

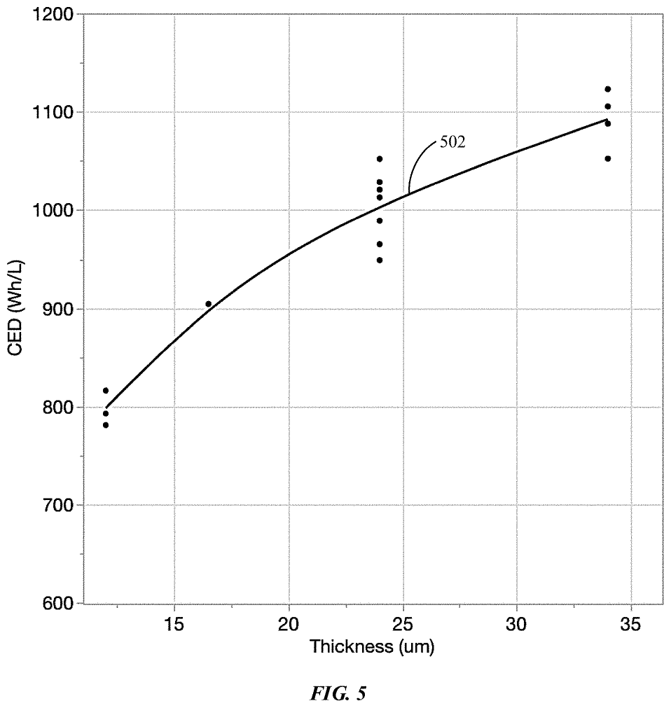

FIG. 5 shows energy density versus cathode thickness for a solid-state Li battery in accordance with embodiments of the disclosure. Curve 502 represents the core energy density (CED) of the disclosed electroplated cathode for the solid-state lithium battery as a function of cathode thickness. As shown in FIG. 5, the energy density increases with cathode thickness for the disclosed cathode of the solid-state lithium battery. At a cathode thickness of 35 μm, the core energy density was about 1123 Wh/L for the solid-state lithium battery, but was only 750-800 Wh/L for the conventional battery. As shown, the energy density was significantly higher for the solid-state lithium battery than the conventional battery.

### Porosity and Relative Density

In some variations, the cathode of the solid-state lithium battery has a dense structure with a low porosity, e.g. to allow solid-state ion diffusion. In further variations, the porosity is less than or equal to 6%. In still further variations, the porosity is less than or equal to 5%. In some variations, the porosity is less than or equal to 4%. In additional variations, the porosity is less than or equal to 3%. For example, the cathode porosity of the solid-state lithium battery is less than or equal to 2%. In some variations, the porosity of the cathode is less than 2.0%. In some variations, the porosity of the cathode is less than 1.5%. In some variations, the porosity of the cathode is less than 1.0%. In some variations, the porosity of the cathode is less than 0.5%.

In some variations, the relative density is greater than 94.0%. In some variations, the relative density is greater than 95.0%. In some variations, the relative density is greater than 96.0%. In some variations, the relative density is greater than 97.0%. In some variations, the relative density is greater than 98.0%. In some variations, the relative density is greater than 98.5%. In some variations, the relative density is greater than 99.0%. In some variations, the relative density is greater than 99.5%.

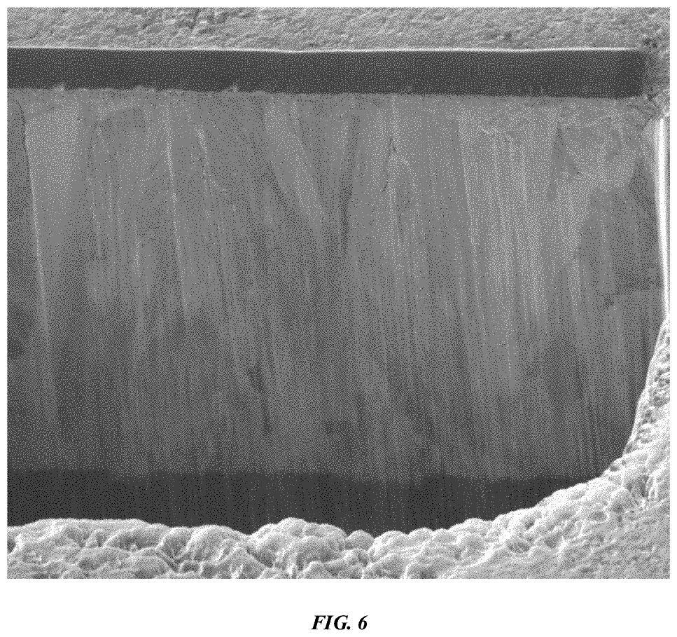

FIG. 6 shows a SEM image of the cross-section of the disclosed electroplated cathode illustrating high relative density and low porosity in accordance with embodiments of the disclosure. The disclosed electroplated cathode for the solid-state battery had a high relative density (e.g. greater than 98%) and a low porosity (e.g. less than 2%), which allowed for solid-state ion diffusion within cathodes. The relative density of the cathode of FIG. 6 was greater than 99.5%.

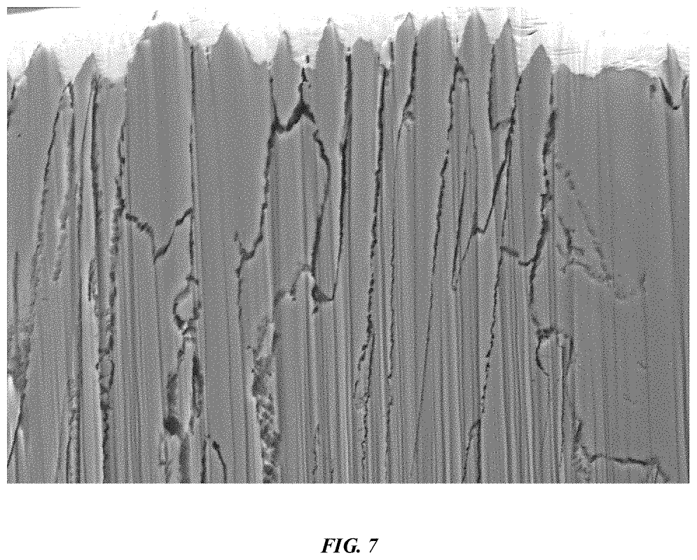

FIG. 7 shows a SEM image of a cross-section of an electroplated cathode for a conventional battery with liquid electrolyte illustrating low density and high porosity in accordance with embodiments of the disclosure. The cathode of the conventional battery had a low relative density (e.g. less than 90%) and a high porosity for infiltration of liquid electrolyte in conventional batteries. The relative density of the cathode of FIG. 7 was less than 90%.

### Surface Roughness

The cathode of the solid-state lithium battery also has low surface roughness, which determines the high yield of the solid-state lithium battery. In contrast, the surface roughness of the cathode is irrelevant for the performance of the conventional Li-ion battery with the liquid electrolyte.

In some variations, the surface roughness is less than 300 nm. In some variations, the surface roughness is less than 250 nm. In some variations, the surface roughness is less than 200 nm. In some variations, the surface roughness is less than 150 nm. In some variations, the surface roughness is less than 100 nm. In some variations, the surface roughness is less than 50 nm.

In some variations, the yield is at least 80%. In some variations, the yield is equal to or greater than 85%. In some variations, the yield is equal to or greater than 90%. In some variations, the yield is equal to or greater than 95%. In some variations, the yield is equal to or greater than 98%. In some variations, the yield is equal to or greater than 99%.

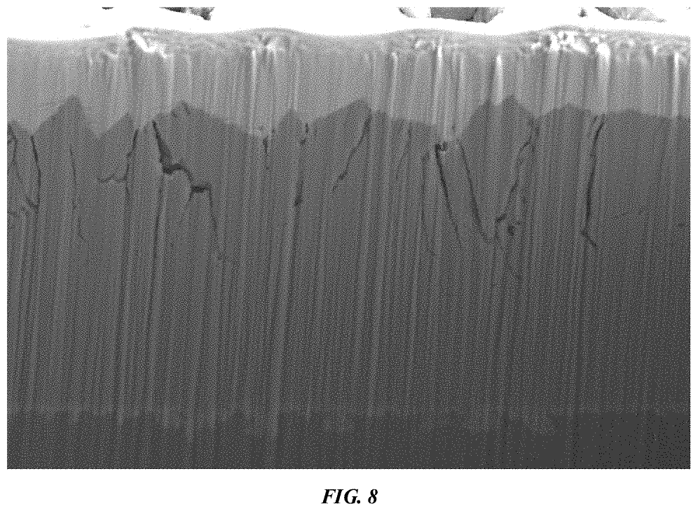

FIG. 8 shows the SEM image of the cross-section of the as-deposited cathode illustrating high surface roughness in accordance with embodiments of the disclosure. As shown in FIG. 8, the as-deposited cathode had a high surface roughness as pointed by an arrow.

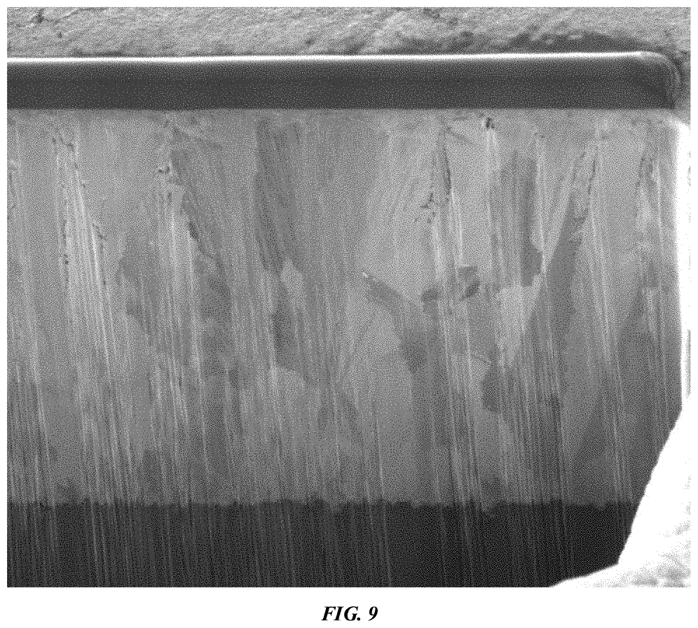

FIG. 9 shows the SEM image of the cross-section of the polished cathode illustrating low surface roughness in accordance with embodiments of the disclosure. As shown in FIG. 9, the polished cathode had a low surface roughness, as pointed by an arrow.

The SEM results revealed that the surface roughness was substantially reduced by polishing process. The low roughness was the foundation for achieving high yield for the solid-state battery. With the low surface roughness, the short circuit or leakiness was then significantly reduced such that the yield was improved.

### Resistance

In some variations, the battery has a resistance between 40 Ω·cm² and 200 Ω·cm². In some variations, the battery has a resistance equal to or greater than 40 Ω·cm². In some variations, the battery has a resistance equal to or greater than 80 Ω·cm². In some variations, the battery has a resistance equal to or greater than 120 Ω·cm². In some variations, the battery has a resistance equal to or greater than 160 Ω·cm². In some variations, the battery has a resistance less than or equal to 80 Ω·cm². In some variations, the battery has a resistance less than or equal to 120 Ω·cm². In some variations, the battery has a resistance less than or equal to 160 Ω·cm². In some variations, the battery has a resistance less than or equal to 200 Ω·cm².

### Diffusivity

In some variations, the cathode has a diffusivity between 1×10⁻⁹ and 1×10⁻⁸ cm²/s. In some variations, the cathode has a diffusivity equal to or greater than 1×10⁻⁹ cm²/s. In some variations, the cathode has a diffusivity equal to or greater than 2×10⁻⁹ cm²/s. In some variations, the cathode has a diffusivity equal to or greater than 4×10⁻⁹ cm²/s. In some variations, the cathode has a diffusivity equal to or greater than 6×10⁻⁹ cm²/s. In some variations, the cathode has a diffusivity equal to or greater than 8×10⁻⁹ cm²/s. In some variations, the cathode has a diffusivity less than or equal to 2×10⁻⁹ cm²/s. In some variations, the cathode has a diffusivity less than or equal to 4×10⁻⁹ cm²/s. In some variations, the cathode has a diffusivity less than or equal to 6×10⁻⁹ cm²/s. In some variations, the cathode has a diffusivity less than or equal to 8×10⁻⁹ cm²/s. In some variations, the cathode has a diffusivity less than or equal to 1×10⁻⁸ cm²/s.

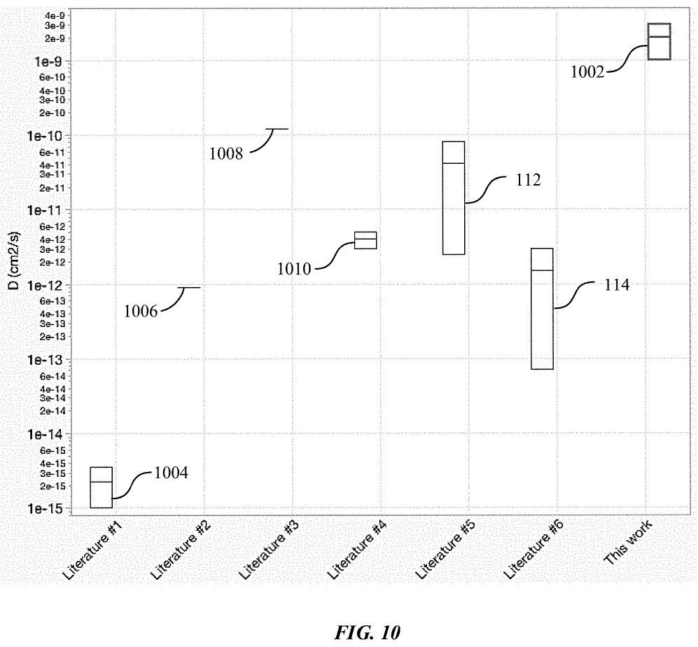

FIG. 10 shows higher Li ion diffusivity of the disclosed electroplated cathode than conventional cathode materials in accordance with embodiments of the disclosure. As shown in FIG. 10, region 1002 represents diffusivity for the disclosed electroplated cathode. Regions 1004, 1006, 1008, 1010, 1012, and 1014 represent diffusivities for six references. The six references are (1) Myung et al., Solid State Ionics, 139: 47-56. (2001); (2) Okubo et al., Solid State Ionics, 180: 612-615. (2009); (3) Cao et al., Electrochem Comm, 9: 1228-1232. (2007); (4) Jang et al., Electrochem Solid State Letter, 4(6): A74-A77. (2001); (5) Levi et al., J. Electrochem Soc, 146(4): 1279-1289. (1999); and (6) Xie et al., Solid State Ionics, 179: 362-370. (2008), each of the six foregoing references is incorporated by references in its entirety. As shown in FIG. 10, the disclosed electroplated cathode had a diffusivity between 1×10⁻⁹ and 1×10⁻⁸ cm²/s, which was much higher than that of all of six references.

### Surface Analysis of Contamination Layer for Polished Cathode

While reducing the roughness, the process of polishing adds a contamination layer to the cathode surface. Surface analysis were performed by using X-ray photoelectron spectroscopy (XPS) after polishing the cathode surface. XPS is a surface-sensitive quantitative spectroscopic technique that measures the elemental composition at the parts per thousand range, chemical state and electronic state of the elements that exist within a material. XPS not only shows what elements, but also show what other elements they are bonded to.

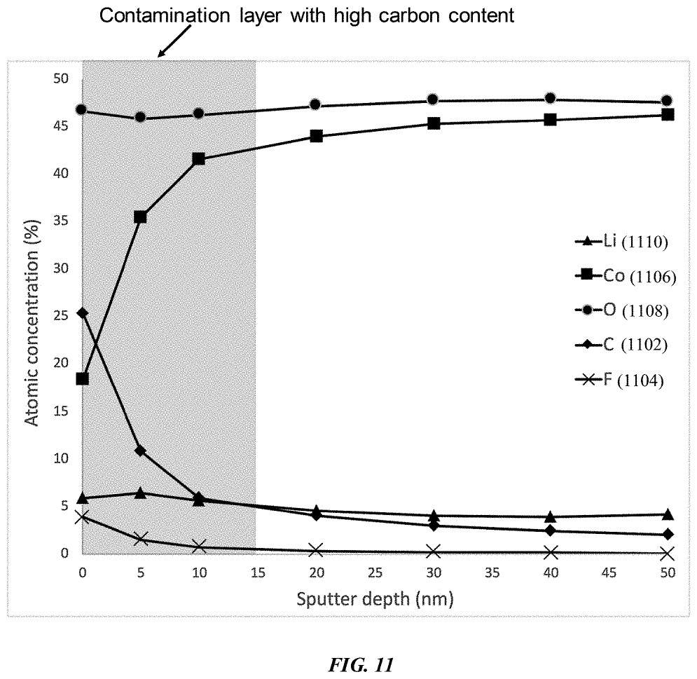

A depth profile of a polished LiCoO₂ cathode surface was obtained by using the XPS. Surface element compositions were obtained at various sputter depths up to 50 nm. FIG. 11 shows atomic concentrations of various elements including carbon (C), fluorine (F), oxygen (O), lithium (Li), and cobalt (Co) versus sputter depth for a polished cathode surface in accordance with embodiments of the disclosure.

Curve 1102 represents carbon (C) as a function of sputter depth. As shown in FIG. 11, the carbon atomic concentration decreased with the sputter depth from about 28 atomic % to about 4 atomic % at a sputter depth of 15 nm. As such, the contamination layer on the cathode surface included a high carbon content. The presence of carbon is not desired on the cathode surface. The presence of high carbon content can correlate to the presence of lithium carbonate. The presence of additional lithium carbonate layer can increase an interfacial resistance of the battery.

Curve 1104 represents fluorine (F) as a function of sputter depth. As shown, the F atomic concentration decreased with the sputter depth from about 4 atomic % to about 1 atomic % at a sputter depth of 15 nm. As such, the contamination layer on the cathode surface included a low fluorine content. The presence of fluorine is not desired on the cathode surface.

Curve 1106 represents cobalt (Co) as a function of sputter depth. As shown, the Co atomic concentration increased with the sputter depth from about 18 atomic % to about 43 atomic % at a sputter depth of 15 nm. Curve 1108 represents oxygen (O) as a function of sputter depth. As shown, the 0 atomic concentration slightly increased with the sputter depth. These results of Co and O relate to the presence of lithium cobalt oxide.

Curve 1110 represents lithium (Li) as a function of sputter depth. As shown, the Li atomic concentration slightly increased to a peak value at a sputter depth of 5 nm and then slightly decreased with the sputter depth up to 50 nm. The additional presence of Li to that in LiCoO₂ can correlate to the presence of lithium carbonate.

By using the depth profile analysis, as shown in FIG. 11, the surface layer or contamination layer was about 10 nm to 20 nm thick. The contamination layer included mainly lithium carbonates, as determined by using XPS.

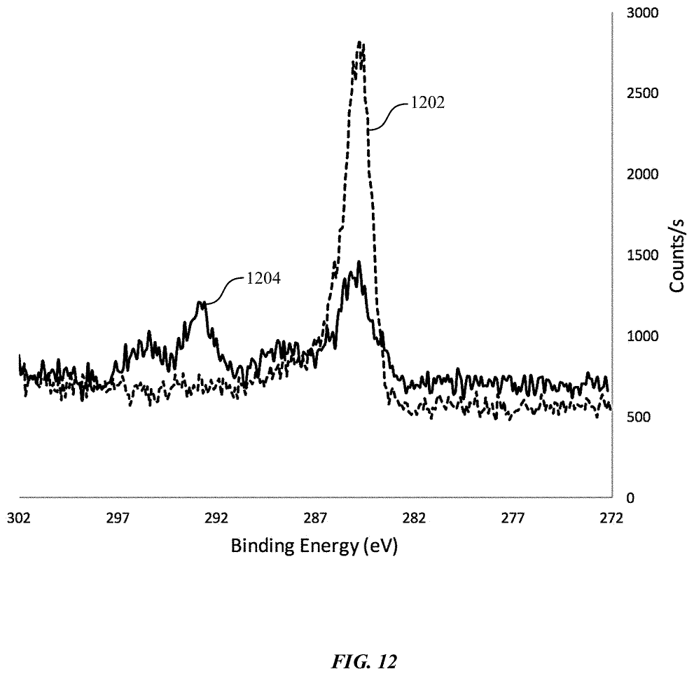

FIG. 12 shows XPS spectra of an as-deposited cathode surface and a polished cathode surface in accordance with embodiments of the disclosure. Curve 1202 represents the polished cathode surface, while Curve 1204 represents the as-deposited cathode surface. As shown by Curve 1204, the as-deposited cathode surface includes a small peak at a binding energy of about 285 eV. As shown by Curve 1202, the polished cathode surface includes a large peak at a binding energy of about 285 eV, which was significantly higher than that of the as-deposited cathode surface. The XPS results suggested that the polished cathode surface was contaminated with lithium carbonates compared to the as-deposited cathode surface.

### Estimation of Thickness of Lithium Carbonate on the Cathode Surface

In some variations, a carbonate surface layer on the cathode is less than 0.01 nm thick. In some variations, a carbonate surface layer on the cathode is less than 0.008 nm thick. In some variations, a carbonate surface layer on the cathode is less than 0.006 nm thick. In some variations, a carbonate surface layer on the cathode is less than 0.004 nm thick. In some variations, a carbonate surface layer on the cathode is less than 0.002 nm thick. In some variations, a carbonate surface layer on the cathode is less than 0.001 nm thick.

Lithium carbonate is an inorganic compound, the lithium salt of carbonate with the formula Li₂CO₃. When the lithium carbonate thickness was 0.01 nm, the additional resistance was 1 Ω·cm², calculated with an ionic conductivity of 10⁻¹² S/cm at room temperature [Ref: Ken Saito, Kenshi Uchida and Meguru Tezuka, Lithium Carbonate as a Solid Electrolyte, Solid State Ionics, 53-56: 791-797. (1992)]. When the lithium carbonate layer thickness increased, the resistance may increase to be above 1 Ω·cm² due to the presence of lithium carbonate on the cathode surface. As such, the lithium carbonate layer must be removed (or to be reduced to <0.01 nm) in order to create a clean interface between the cathode and the electrolyte. The electrochemical performance of the battery would not be compromised due to the improvement of the yield through polishing to reduce the surface roughness.

### Cycling and Rate Performance

LiCoO₂ cathodes were assembled into batteries with a Li metal anode, and a solid electrolyte LiPON. Galvanostatic charge/discharge cycling was conducted in the 3.0-4.25 V range at various C-rates at 25° C. The batteries were cycled up to 100 times. Such cycling can be carried out using a battery cycler or a galvanostatic tester (e.g., Maccor 4200) attached to a computer.

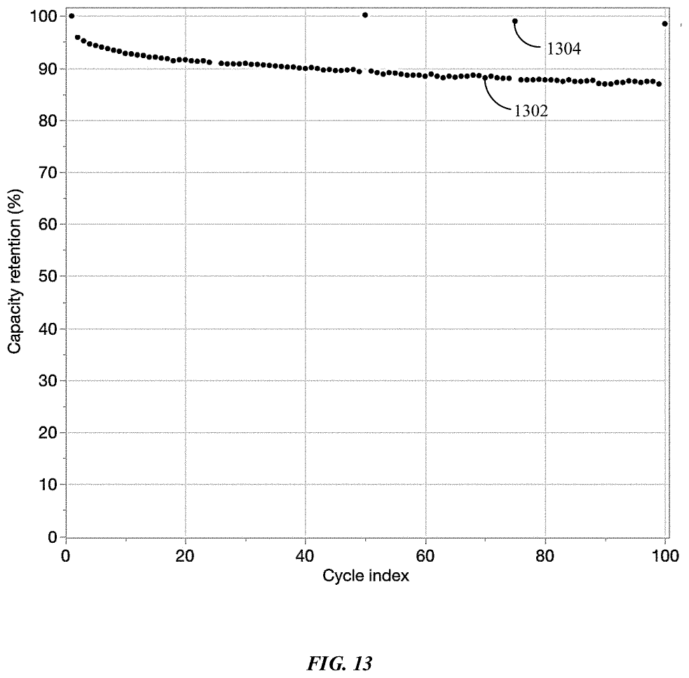

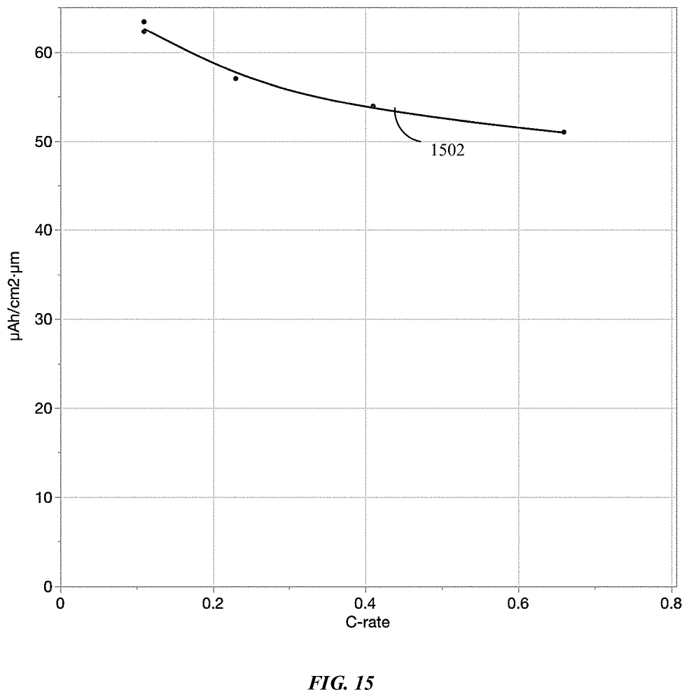

FIG. 13 shows capacity versus cycles for the solid-state Li battery in accordance with embodiments of the disclosure. Dots 1304 represent the capacity of the solid-state Li battery at various number of cycles including 1^{st} cycle, 25^{th} cycle, 50^{th} cycle, 75^{th} cycle, and 100^{th} cycle at a rate of 0.2 C. Curve 1502 represents the capacity of the solid-state Li battery as a function of the number of cycles at a rate of 0.5 C. The capacity at both 0.2 C and 0.5 C was shown in percentage with respect to the capacity in the first cycle. As shown in FIG. 15, the capacity was higher at 0.2 C than 0.5 C. The capacity decreased slightly with increased number of cycles. For example, the capacity retention was about 98% at 100^{th} cycle at 0.2 C. Such a high retention in capacity indicate good reversibility of the battery upon charge and discharge cycles.

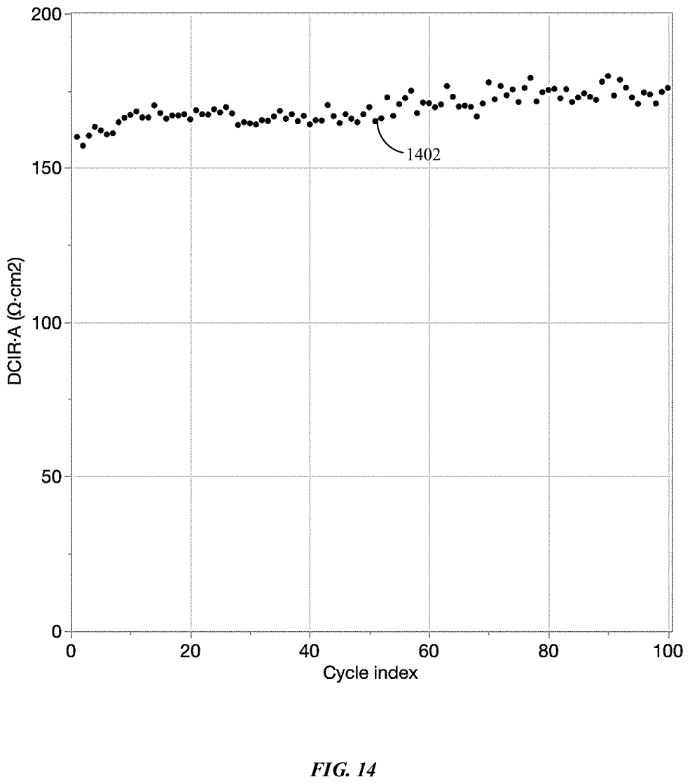

FIG. 14 shows resistance versus cycles for the solid-state Li battery in accordance with embodiments of the disclosure. Curve 1402 represents resistance data points versus number of cycles. As shown in FIG. 14, the resistance slightly increased with the number of cycles from about 160 Ω/cm² at the first cycle to a value between 170 Ω·cm² and 180 Ω·cm² at 100^{th} cycle.

FIG. 15 shows capacity versus discharge rates for the solid-state Li battery in accordance with embodiments of the disclosure. Curve 1502 represents the capacity as a function of C-rate. As shown in FIG. 15, the capacity retention is reasonably good at higher C-rates. For example, the capacity was about 63 μAh/cm²μm at 0.11 C, and 52 μAh/cm²μm at 0.66 C, which resulted in about 83% retention.

Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the method and system, which, as a matter of language, might be said to fall therebetween.

What is claimed is:

1. A solid-state battery comprising:
a cathode comprising a lithium-based conducting material having a porosity less than or equal to 6% and a surface roughness of less than or equal 300 nm;
an anode; and
a solid electrolyte between the cathode and the anode.

2. The solid-state battery of claim 1, wherein the lithium-based conducting material comprises a material selected from the group consisting of LiCoO₂, LiNiO₂, LiMn₂O₄, LiNi_{0.5}Mn_{1.5}O₄, Li(Ni_{1/3}Mn_{1/3}Co_{1/3})O₂, Li(Ni_{0.8}Co_{0.1}Al_{0.1})O₂, and Li₃VO₄.

3. The solid-state battery of claim 1, wherein the cathode has a diffusivity between 1×10⁻⁹ and 1×10⁻⁸ cm²/s.

4. The solid-state battery of claim 1, wherein the cathode has a thickness ranging from 10 μm to 200 μm.

5. The solid-state battery of claim 1, wherein the solid-state battery has a resistance between 40 Ω·cm² and 200 Ω·cm².

6. The solid-state battery of claim 1, wherein a carbonate surface layer on the cathode is less than 0.01 nm thick.

7. The solid-state battery of claim 6, wherein the carbonate surface layer comprises lithium carbonate.

8. A solid-state battery comprising:
a cathode comprising a lithium-based conducting material having a diffusivity between 1×10⁻⁹ and 1×10⁻⁸ cm²/s;
an anode; and
a solid electrolyte between the cathode and the anode.

9. The solid-state battery of claim 8, wherein the lithium-based conducting material comprises a material selected from the group consisting of LiCoO₂, LiNiO₂, LiMn₂O₄, LiNi_{0.5}Mn_{1.5}O₄, Li(Ni_{1/3}Mn_{1/3}Co_{1/3})O₂, Li(Ni_{0.8}Co_{0.1}Al_{0.1})O₂, and Li₃VO₄.

10. The solid-state battery of claim 8, wherein the cathode has a porosity less than or equal to 2% and a surface roughness of less than or equal to 300 nm.

11. The solid-state battery of claim 8, wherein the cathode has a thickness ranging from 10 μm to 200 μm.

12. The solid-state battery of claim 8, wherein the solid-state battery has a resistance between 40 Ω·cm² and 200 Ω·cm².

13. The solid-state battery of claim 8, wherein a carbonate surface layer on the cathode is less than 0.01 nm thick.

14. The solid-state battery of claim 13, wherein the carbonate surface layer comprises lithium carbonate.

15. A solid-state battery comprising:
a cathode comprising a lithium-based conducting material;
an anode; and
a solid electrolyte between the cathode and the anode, wherein the solid-state battery has a resistance between 40 Ω·cm² and 200 Ω·cm².

16. The solid-state battery of claim 15, wherein the lithium-based conducting material comprises a material selected from the group consisting of LiCoO₂, LiNiO₂, LiMn₂O₄, LiNi_{0.5}Mn_{1.5}O₄, Li(Ni_{1/3}Mn_{1/3}Co_{1/3})O₂, Li(Ni_{0.8}Co_{0.1}Al_{0.1})O₂, and Li₃VO₄.

17. The solid-state battery of claim 15, wherein the cathode has a porosity less than or equal to 2% and a surface roughness of less than or equal to 300 nm.

18. The solid-state battery of claim 15, wherein the cathode has a thickness ranging from 10 μm to 200 μm.

19. The solid-state battery of claim 15, wherein the cathode has a diffusivity between 1×10⁻⁹ and 1×10⁻⁸ cm²/s.

20. The solid-state battery of any claim 15, wherein a carbonate surface layer on the cathode is less than 0.01 nm thick.

21. The solid-state battery of any claim 20, wherein the carbonate surface layer comprises lithium carbonate.

22. The solid-state battery of claim 15, wherein the solid electrolyte comprises LiPON.

23. The solid-state battery of claim 15, wherein the battery has a yield of at least 80%.

24. A method of forming the cathode of any one of claims, the method comprising:
forming the cathode by a film deposition technique;
polishing a surface of the cathode; and
re-activating the surface of the cathode by cleaning through oxygen plasma treatment.
